(19) United States
(12) Patent Application Publication
(10) Pub. No.: US 2015/0293141 A1
(43) Pub. Date: Oct. 15, 2015

(54) MIRCO-ELECTRO-MECHANICAL SYSTEM DEVICE

(71) Applicants: Chia-Yu Wu, Zhubei City (TW); Chiung-Wen Lin, Zhubei City (TW); Chiung-Cheng Lo, Zhubei City (TW)

(72) Inventors: Chia-Yu Wu, Zhubei City (TW); Chiung-Wen Lin, Zhubei City (TW); Chiung-Cheng Lo, Zhubei City (TW)

(73) Assignee: RICHTEK TECHNOLOGY CORPORATION, Zhubei City (TW)

(21) Appl. No.: 14/681,991

(22) Filed: Apr. 8, 2015

Related U.S. Application Data
(60) Provisional application No. 61/977,297, filed on Apr. 9, 2014.

(51) Int. Cl. G01P 15/08; G01P 15/135; G01P 15/125

(52) U.S. Cl. CPC G01P 15/0888; G01P 15/125; G01P 15/135; G01P 2015/0862

(57) ABSTRACT

The present invention discloses a micro-electro-mechanical system (MEMS) device. The MEMS device includes: a substrate; a proof mass which defines an internal space inside and forms at least two capacitors with the substrate; at least two anchors connected to the substrate and respectively located in the capacitor areas of the capacitors from a cross-sectional view; at least one linkage truss located in the hollow structure, wherein the linkage truss is directly connected to the anchors or indirectly connected to the anchors through buffer springs; and multiple rotation springs located in the hollow structure, wherein the rotation springs are connected between the proof mass and the linkage truss, such that the proof mass can rotate along an axis formed by the rotation springs. There is no coupling mass which does not form a movable electrode in the connection between the proof mass and the substrate.

### CROSS REFERENCE

The present invention claims priority to U.S. 61/977,297, filed on Apr. 9, 2014.

### BACKGROUND OF THE INVENTION

1. Field of Invention

The present invention relates to a micro-electro-mechanical system (MEMS) device, in particular a MEMS device having anchors located below the proof mass, and the proof mass and the anchors are directly connected by springs without any coupling mass in between.

2. Description of Related Art

FIG. 1A shows a conventional MEMS device 10, which includes a substrate 11, a proof mass 12, and an anchor 13. The proof mass 12 is connected to the substrate 11 through the anchor 13. The substrate 11 includes fixed electrodes 111 and the proof mass 12 includes movable electrodes 121. The fixed electrodes 111 and the movable electrodes 121 form sensing capacitors for sensing a movement of the MEMS device 10. More specifically, the sensing capacitor at the left side of the anchor 13 and the sensing capacitor at the right side of the anchor 13 form a pair of differential capacitors. When the MEMS device 10 moves, the proof mass 12 rotates in the Z-direction, and the differential capacitors help to sense the movement of the MEMS device 10 in the z-direction more accurately. Because of the design of the differential capacitors, the anchor 13 is naturally positioned at a location between the pair of differential capacitors. However, this prior art MEMS device 10 has a drawback. FIG. 1B shows that the substrate 11 undergoes a deformation due to stress in the manufacturing process or in operation. Comparing FIG. 1B with FIG. 1A, and it can be seen that the distances between the fixed electrodes 111 and the movable electrodes 121 have changed. This change is unpredictable and uncontrollable. Such a drawback exists also in the MEMS devices disclosed in U.S. Pat. No. 4,736,629 and U.S. Pat. No. 5,487,305.

FIG. 2 shows a MEMS device 20 disclosed in U.S. Pat. No. 8,434,364. The MEMS device 20 includes a proof mass 22, anchors 23, springs 24a and 24b, and a coupling mass 25. The proof mass 22 and the coupling mass 25 are suspended above a substrate (not shown), and the proof mass 22 is connected to the substrate through the springs 24a, the coupling mass 25, and the springs 24b. The anchors 23 are positioned below the proof mass 22 instead of a location between the differential capacitors, so the inaccuracy caused by deformation is reduced. However, this prior art has a drawback that, in order to connect the proof mass 22 to the anchors 23 below the proof mass 22, a coupling mass 25 which does not form a movable electrode is used. This coupling mass 25 does not form a capacitor with a corresponding fixed electrode, so it does not contribute to signal sensing, but it wastes a significant layout area. That is, in order to provide a space for the coupling mass 25, the effective sensing area of the proof mass 22 is reduced; or, to provide the same effective sensing area of the proof mass 22, the overall layout area needs to be increased.

In view of the above, the present invention proposes a MEMS device without the drawbacks in the prior art MEMS devices.

### SUMMARY OF THE INVENTION

From one perspective, the present invention provides a MEMS device which includes: a substrate including at least two fixed electrode regions, the substrate has an out-of-plane direction which is normal to a surface of the substrate; a proof mass which defines an internal space inside, the proof mass including at least two movable electrode regions which form at least two capacitors with the at least two fixed electrode regions; at least two anchors connected to the substrate; at least one linkage truss located in the internal space, wherein the linkage truss is directly connected to the anchors or indirectly connected to the anchors through buffer springs; and a plurality of rotation springs located in the internal space, wherein each rotation spring has one end connected to the proof mass and another end connected to the linkage truss; wherein the at least two capacitors are located at two sides of a rotation axis formed by the rotation springs, such that the proof mass can rotate along the axis formed by the rotation springs for sensing a movement of the MEMS device in the out-of-plane direction, and wherein there is no coupling mass which does not form a movable electrode in the connection between the proof mass and the substrate.

In one preferable embodiment, from a cross-sectional view, the anchors are respectively areas in capacitor areas of the at least two capacitors.

In one preferable embodiment, each anchor is positioned at a location having a predetermined relationship with one or more fixed electrode regions.

In one preferable embodiment, each anchor is positioned at a location corresponding to a geometrical center of one of the fixed electrode regions, or each anchor is positioned on an imaginary connecting line which connects geometrical centers of two of the fixed electrode regions.

In one preferable embodiment, the linkage truss includes at least one outer part and an interconnecting part connecting the at least one outer part.

In one preferable embodiment, when the linkage truss is directly connected to the anchors, the linkage truss includes a buffer region which has a winding shape to provide a buffering effect.

In one preferable embodiment, when the linkage truss is indirectly connected to the anchors through buffer springs, the buffer springs are O-shaped springs, rotation springs, S-shaped springs or U-shape springs.

In one preferable embodiment, a center of gravity of the proof mass has a distance with the axis formed by the rotation springs so that the proof mass can perform an eccentric movement.

In one preferable embodiment, the MEMS device comprises at least four anchors, at least four buffer springs and at least two linkage trusses, and wherein each linkage truss connects at least two buffer springs and one rotation spring.

In one preferable embodiment, the MEMS device includes at least four capacitors.

In one preferable embodiment, a rigidity of the linkage truss is higher than a rigidity of the buffer springs but lower than a rigidity of the substrate.

The objectives, technical details, features, and effects of the present invention will be better understood with regard to the detailed description of the embodiments below.

### BRIEF DESCRIPTION OF THE DRAWINGS

FIGS. 1A and 1B show a conventional MEMS device.

FIG. 2 shows another conventional MEMS device

FIG. 3 shows a MEMS device according to an embodiment of the present invention.

FIGS. 4A and 4B show cross-sectional views of the MEMS device of FIG. 3, illustrating the relationship between the fixed electrodes and the movable electrodes when the substrate suffers deformation.

FIGS. 5-9 show MEMS devices according to several other embodiments of the present invention.

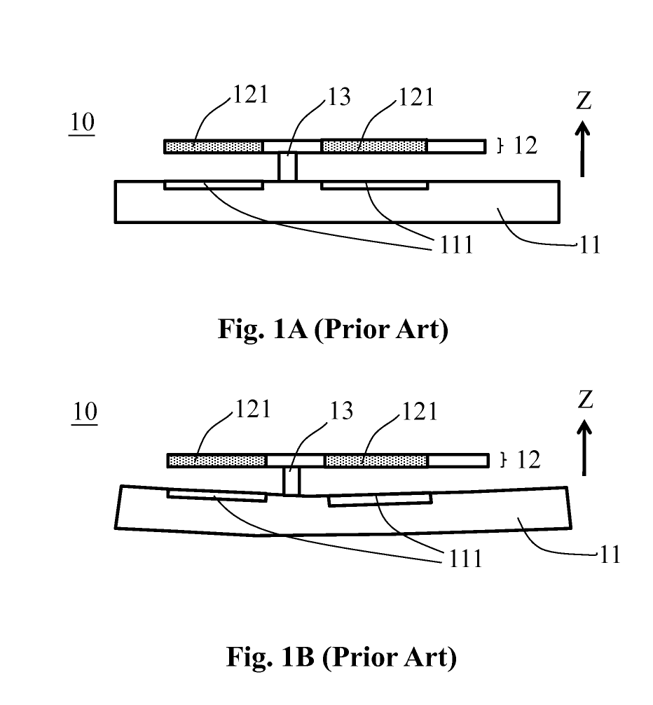

### DESCRIPTION OF THE PREFERRED EMBODIMENTS

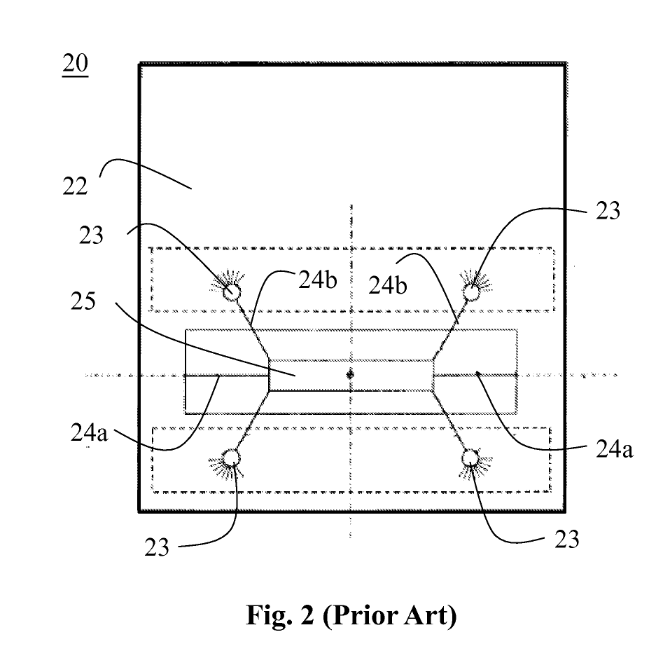

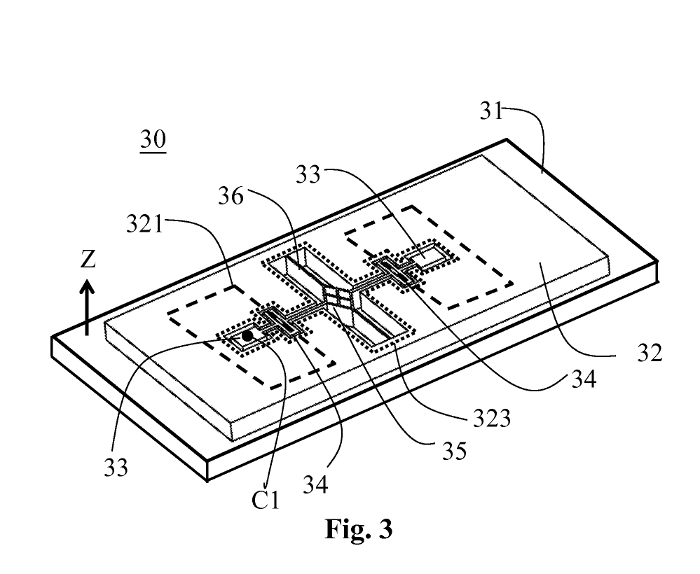

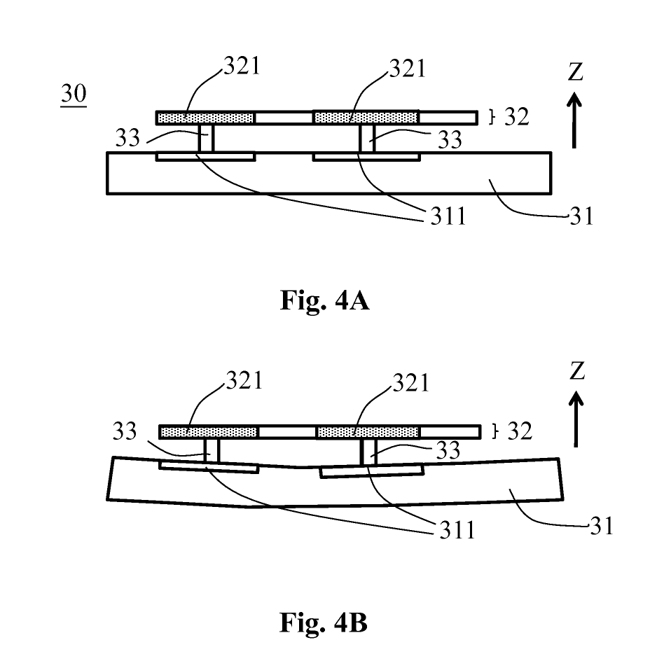

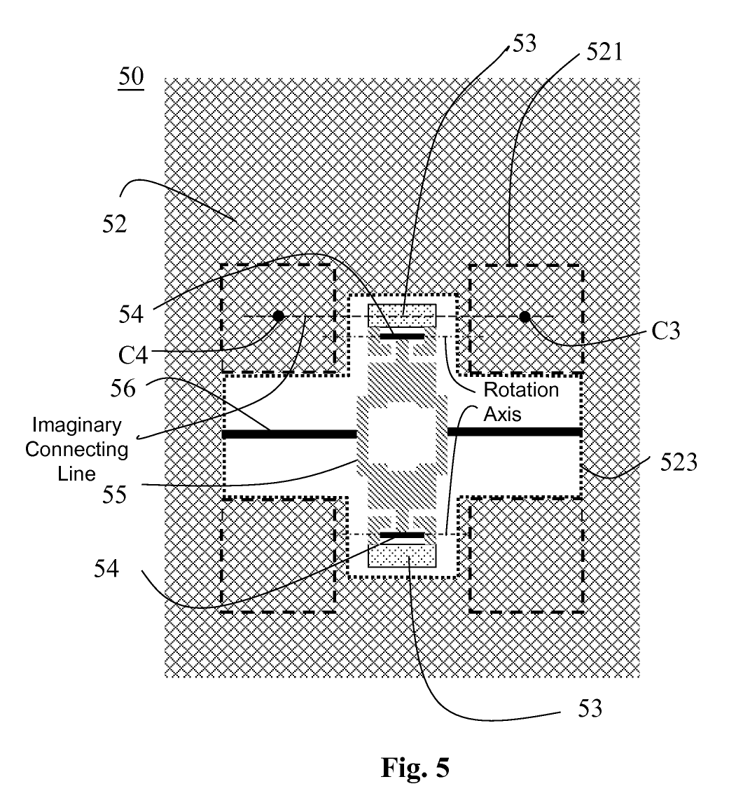

Please refer to FIGS. 3, 4A and 4B for a MEMS device 30 according to a first embodiment of the present invention. The MEMS device 30 includes a substrate 31, a proof mass 32, at least two anchors 33 (two in this embodiment but can be more in other embodiments), buffer springs 34 having a number corresponding to the number of the anchors 33, a linkage truss 35, and plural rotation springs 36 (two in this embodiment but can be more in other embodiments). Referring to FIGS. 4A and 4B, the proof mass 32 includes at least two movable electrode regions 321 and the substrate 31 includes a corresponding number of fixed electrode regions 311, forming differential capacitors for sensing a movement of the MEMS device 30 in an out-of-plane direction Z which is normal to a surface of the substrate 31. The anchors 33 are connected to the substrate 31, and as seen from the cross-sectional views, the anchors 33 are located in the capacitor areas of the differential capacitors (however, from a top view such as in the embodiments of FIGS. 5-7, the anchors 33 need not be positioned in the fixed electrode regions 321). Each buffer spring 34 has one end connected to a corresponding anchor 33, and the other end connected to the linkage truss 35. The proof mass 32 defines an inner space 323 inside the proof mass 32, and the linkage truss 35 is located inside the inner space 323. The proof mass 32 is connected to the linkage truss 35 through the rotation springs 36. That is, the proof mass 32 is connected to the substrate 31 through the rotation springs 36, the linkage truss 35, the buffer springs 34 and the anchors 33. Note that in the connection between the proof mass 32 and the substrate 31, there is no coupling mass (a mass that does not form any movable electrode) as in the prior art of FIG. 2. Hence, in the present invention, the effective sensing area of the proof mass 32 is increased; or, for the same effective sensing area of the proof mass 32, the overall layout area needs to be increased.

Each rotation spring 36 has one end connected to the proof mass 32 and the other end connected to the linkage truss 35. In this embodiment, the proof mass 32 can rotate along an axis formed by the rotation springs 36, such that the capacitors at the two sides of the rotation springs 36 form differential capacitors (that is, the fixed electrode regions 311 and the movable electrode regions 321 form at least one capacitor at each side of the axis formed by the rotation springs 36). The anchors 33 and the buffer springs 34 are located at the two sides of the axis formed by the rotation springs 36.

FIGS. 4A and 4B are cross-sectional views showing that, when the substrate 31 suffers deformation while the proof mass is not deformed, the distances between the movable electrode regions 321 and the fixed electrode regions 311 increase at one side of an anchor 33 but decrease at the other side of the same anchor 33. Therefore, the deformation of the substrate 31 does not significantly affect the sensing accuracy of the MEMS device 30.

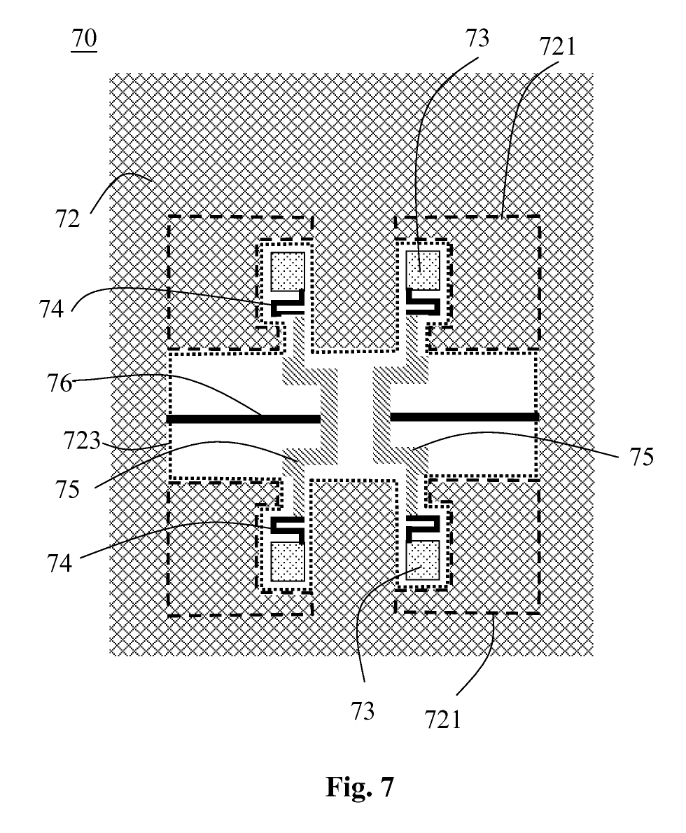

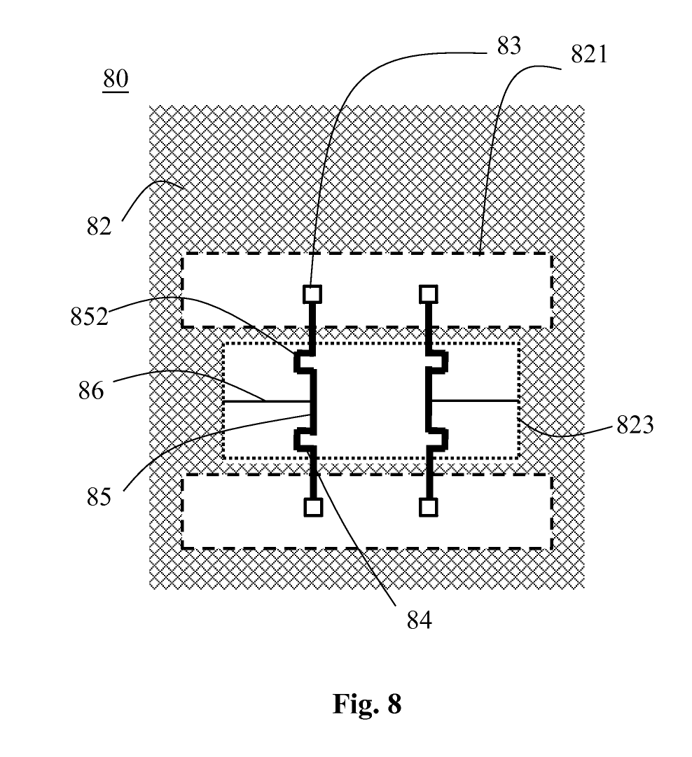

The buffer springs 34 are not limited to having an O-shape as shown in the above embodiment. FIG. 5 shows that the MEMS device 50 includes two buffer springs 54 which are rotation springs rotatable along the rotation axes shown in the figure. FIG. 7 shows S-shaped buffer springs 74, and FIG. 8 shows U-shaped buffer springs 84. The above-mentioned shapes and operations of the buffer springs are several preferred but non-limiting examples.

In one embodiment, each anchor is positioned at a location having a predetermined relationship with one or more fixed electrode regions. For example, referring to FIG. 3, each anchor 33 is positioned at a location corresponding to a geometrical center of a fixed electrode region 321; or, referring to FIG. 5, each anchor 53 is positioned on an imaginary connecting line which connects the geometrical centers (e.g. C3 and C4) of two fixed electrode regions 521.

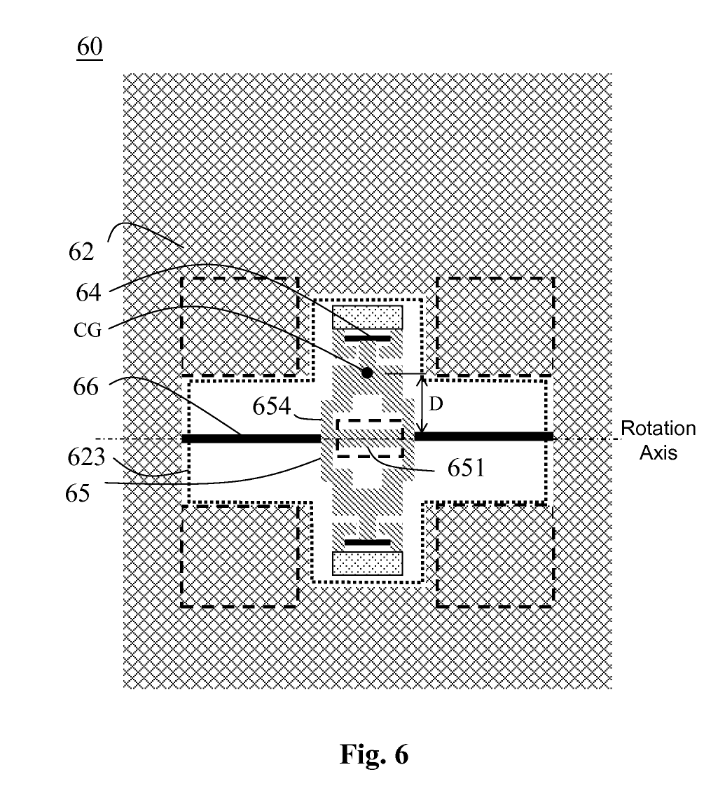

FIG. 6 shows that, in one embodiment, there is a distance D between the center of gravity of the proof mass 62 and the rotation axis formed by the rotation springs 66 in the MEMS device 60; that is, the mass quantity of the proof mass 62 is unevenly distributed at the two sides of the rotation axis formed by the rotation springs 66, so that the proof mass 62 can perform an eccentric movement.

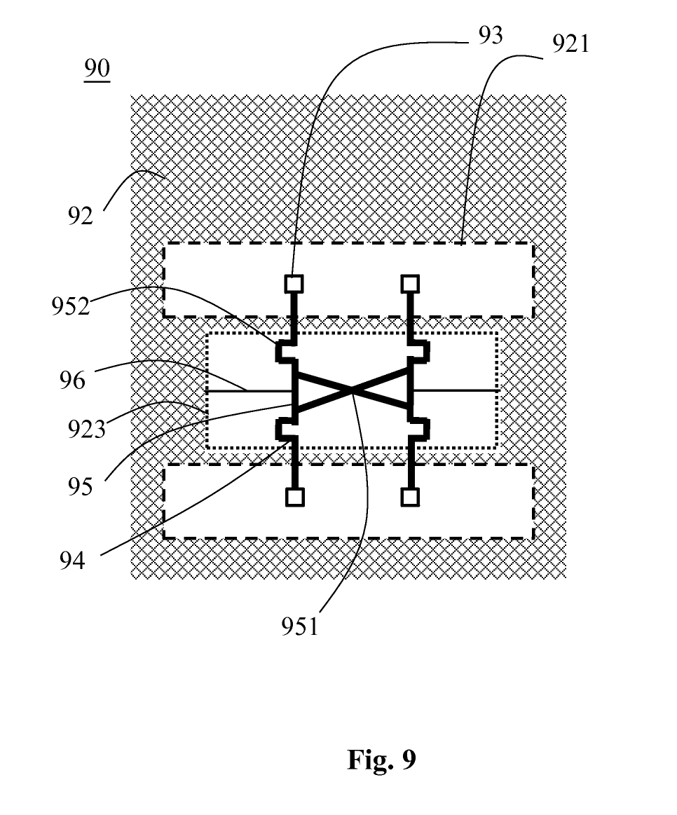

Comparing the two embodiments shown in FIGS. 5 and 6, the linkage truss 65 includes an additional interconnecting part 651 connecting an outer part 654 of the linkage truss 65, to strengthen the structure. In one preferred embodiment, the rigidity of the linkage truss is higher than the rigidity of the buffer springs, so that the linkage truss is less affected by the deformation of the substrate. In the embodiment of FIG. 9, two linkage trusses 95 are connected by an interconnecting part 951 (or, from another point of view, it can be regarded as that there is only one linkage truss which includes two outer parts connected by the interconnecting part 951). In another embodiment, the rigidity of the linkage truss is lower than the rigidity of the substrate, so as to less affect the sensitivity of the proof mass.

In the embodiment shown in FIG. 3, two anchors 33 are connected to one same linkage truss 35 through two buffer springs 34, and the one same linkage truss 35 is connected to every rotation springs 36. However, the present invention is not limited to such an arrangement. For example, as shown in FIG. 7, in another embodiment, the MEMS device 70 includes four anchors 73, connected to two linkage trusses 75 through four buffer springs 74. Each linkage truss 75 connects two buffer springs 74 and one rotation spring 76. (Or, from another point of view, it can be regarded as that the embodiment of FIG. 7 includes one linkage truss which includes two separated outer parts). Moreover, in the embodiment of FIG. 7, the proof mass 72 includes four movable electrode regions 721 corresponding to four fixed electrode regions on the substrate (not shown). This shows that the number of the sensing capacitors can be arranged as required.

In short, the numbers of the anchors, buffer springs, linkage truss, rotation springs, fixed electrode regions, movable electrode regions and sensing capacitors are not limited to the embodiments and can be changed.

In the embodiments of FIGS. 3 and 5-7, the buffer springs 34, 54, 64 and 74 respectively connect the linkage trusses 35, 55, 65 and 75 to corresponding anchors 33, 53, 63 and 73. Referring to FIGS. 8 and 9, in other embodiments, the buffer springs can be omitted. Under such circumstance wherein no buffer spring is provided, preferred but not necessary, buffer regions 852 and 952 can be provided in the linkage trusses 85 and 95. The buffer regions 852 and 952 are parts of the linkage trusses 85 and 95, which are made by the same material or materials as the rest parts of the linkage trusses 85 and 95, except that the buffer regions 852 and 952 have a winding shape to provide a buffering effect.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. In view of the foregoing, the spirit of the present invention should cover all such and other modifications and variations, which should be interpreted to fall within the scope of the following claims and their equivalents.

What is claimed is:

1. A micro-electro-mechanical system (MEMS) device, comprising:
a substrate including at least two fixed electrode regions, the substrate has an out-of-plane direction which is normal to a surface of the substrate;
a proof mass which defines an internal space inside, the proof mass including at least two movable electrode regions which form at least two capacitors with the at least two fixed electrode regions;
at least two anchors connected to the substrate;
at least one linkage truss located in the internal space, wherein the linkage truss is directly connected to the anchors or indirectly connected to the anchors through buffer springs; and
a plurality of rotation springs located in the internal space, wherein each rotation spring has one end connected to the proof mass and another end connected to the linkage truss;
wherein the at least two capacitors are located at two sides of a rotation axis formed by the rotation springs, such that the proof mass can rotate along the axis formed by the rotation springs for sensing a movement of the MEMS device in the out-of-plane direction, and wherein there is no coupling mass which does not form a movable electrode in the connection between the proof mass and the substrate.

2. The MEMS device of claim 1, wherein from a cross-sectional view, the anchors are respectively areas in capacitor areas of the at least two capacitors.

3. The MEMS device of claim 1, wherein each anchor is positioned at a location having a predetermined relationship with one or more fixed electrode regions.

4. The MEMS device of claim 3, wherein each anchor is positioned at a location corresponding to a geometrical center of one of the fixed electrode regions, or each anchor is positioned on an imaginary connecting line which connects geometrical centers of two of the fixed electrode regions.

5. The MEMS device of claim 1, wherein the linkage truss includes at least one outer part and an interconnecting part connecting the at least one outer part.

6. The MEMS device of claim 1, wherein when the linkage truss is directly connected to the anchors, the linkage truss includes a buffer region which has a winding shape to provide a buffering effect.

7. The MEMS device of claim 1, wherein when the linkage truss is indirectly connected to the anchors through buffer springs, the buffer springs are O-shaped springs, rotation springs, S-shaped springs or U-shape springs.

8. The MEMS device of claim 1, wherein a center of gravity of the proof mass has a distance with the axis formed by the rotation springs so that the proof mass can perform an eccentric movement.

9. The MEMS device of claim 1, wherein the MEMS device comprises at least four anchors, at least four buffer springs and at least two linkage trusses, and wherein each linkage truss connects at least two buffer springs and one rotation spring.

10. The MEMS device of claim 1, comprising at least four capacitors.

11. The MEMS device of claim 1, wherein a rigidity of the linkage truss is higher than a rigidity of the buffer springs but lower than a rigidity of the substrate.
